(19) United States
(12) Patent Application Publication
(10) Pub. No.: US 2004/0259760 A1
(43) Pub. Date: Dec. 23, 2004

(54) Solid cationic surfactants

(76) Inventors: Hendrick Petrus Frick, Ayrshire (GB); Stuart William Jackson, North Yorkshire (GB); Ajit Kumar, West Midlands (GB)

Correspondence Address: Legal Department, Huntsman, PO Box 15730, Austin, TX, 78761, US

(21) Appl. No.: 10/486,506

(22) PCT Filed: Aug. 5, 2002
(86) PCT No.: PCT/EP02/08710

(30) Foreign Application Priority Data
Aug. 14, 2001 (GB) 0119770.6

(51) Int. Cl. C11D 1/00

(52) U.S. Cl. 510/499

(57) ABSTRACT

A free-flowing non-deliquescent benzalkonium salt having a C?10 to 25? alkyl group, said group consisting of at least 90% by weight of a single homologue, and from 3 to 10% by weight of water.

The present invention relates to solid cationic surfactants and to methods for their preparation.

Aqueous cationic surfactants are usually only pourable at relatively low concentrations, eg up to about 30% to 34% by wt. in a typical case. The formation of immobile or very highly viscous mesophases prevents their being produced and used at higher concentrations, except by using organic solvents, which are undesirable on grounds of cost, fire hazard, environmental impact and possible adverse effects on any formulation in which the surfactant may be incorporated. It is nevertheless desirable that surfactants be supplied at as high a concentration as possible in order to reduce storage and transport costs, to obviate the need for preservatives and to give formulators greater flexibility to make formulations containing low levels of water.

For most purposes surfactants are preferably supplied as spray dried or drum dried solids which are substantially anhydrous. However, cationic surfactants cannot be supplied as solids, in practice, because they are too hygroscopic. They are generally deliquescent, the powder absorbing sufficient moisture to form a highly viscous intractable M-phase.

Cationic surfactants are generally prepared by neutralising or quaternising amines with acids or organic quaternising agents respectively. They are important because of their substantiveness to hair and fabrics, leading to their use in shampoos, hair conditioners and fabric conditioners. They have biocidal properties leading to their use in disinfectants. Particularly important are the benzalkonium salts made by the reaction of benzyl chloride with a tertiary amine, e.g:

R¹R²R³N+C₆H₅CH₂Cl→R¹R²R³N⁺CH₂C₆H₅+Cl⁻

wherein R¹ is a C₈₋₂₅ alkyl or alkylamido alkylene group, R² is a C₈₋₂₅ alkyl group or a C₁₋₄ alkyl or hydroxy alkyl group and R³ is a C₁₋₄ alkyl or hydroxy alkyl group, usually a methyl group, or R² and R³ together, constitute a heterocyclic ring.

We have now discovered that, unlike most other cationic surfactants, benzalkonium salts derived from an amine feedstock R¹R²R³N consisting at least predominantly (e.g. more than 90%) of a single homologue, when dried to a water content of from 3 to 10% by weight, can be obtained as a stable, non-hygroscopic, free-flowing powder, provided that drying is effected at a temperature below the softening point of the product.

Our invention provides a free-flowing non-deliquescent benzalkonium salt having at least one C₈₋₂₅ alkyl group and obtained by benzylating a tertiary amine consisting of at least 90% by weight of a single homologue, said salt containing from 3 to 10% by weight of water. Preferably said alkyl group has at least 10 carbon atoms.

The products of our invention are preferably substantially non-hygroscopic. By this is meant that they form a solid having an equilibrium water content below 10% at 40° C. in an atmosphere having 65% humidity.

Preferably the inorganic salt content of the dried product is less than 12% by weight, more preferably less than 9%, typically less than 7.5%, more typically less than 6%, most typically less than 4.5% especially less than 3%, more especially less than 0.75%, most especially less than 0.5%.

Salt may be removed from the aqueous feed, if necessary by any convenient method such as membrane filtration or electrodialysis.

Preferably the amine has more than 90% more preferably more than 94%, most preferably more than 95%, by weight consisting of a single homologue. However for commercial reasons it is not practical, or necessary to use a feedstock that is more than 99.5% pure, or even 99%. Typically the purity of the feedstock is less than 98.5% e.g. 96 to 98%.

The amine is preferably a tertiary amine and most preferably lauryl dimethylamine.

Alternatively, the amine may, for example, be decyl, palmityl or stearyl dimethylamine, a lauroyl imidazoline, or decyl amidopropyl diethylamine.

The water content is preferably reduced to a value of from 3.5 to 9% more preferably 4 to 8% especially 4.5 to 7% eg 5 to 6.5%. Drying may, for example, be effected by the application of heat and/or reduced pressure, eg in a spray drier or by freeze-drying. It is usually desirable to dry at temperatures below the softening point of the product.

The invention is illustrated by the following example:

Coconut dimethylamine was quaternised with benzylchloride. Attempts to freeze dry the product to below 5% moisture resulted in a highly deliquescent product, which absorbed moisture from the atmosphere to form an intractable m-phase.

The coconut dimethylamine was replaced with an amine feedstock comprising 98% pure lauryl dimethylamine prepared from a fractionated coconut oil. The dried product at 5% moisture was a free flowing non-hygroscopic powder.

1. A free-flowing non-deliquescent benzalkonium salt having at least one C₈₋₂₅ alkyl group and obtained by benzylating a tertiary amine consisting of at least 90% by weight of a single homologue, said salt containing from 3 to 10% by weight of water based on the total weight of said salt.

2. A salt according to claim 1, having an equilibrium water content below 10% based on the total weight of said salt at 40° C. in an atmosphere having 65% humidity.

3. A salt according claim 1 having an inorganic salt content of less than 12% by weight based on the total weight of said salt.

4. salt according claim 1 having an inorganic salt content of less than 9% by weight based on the total weight of said salt.

5. A salt according to claim 1 having an inorganic salt content of less than 0.5% by weight based on the total weight of said salt.

6. A salt according to claim 1 wherein said tertiary amine consists of more than 95%, by weight of said amine, of a single homologue.

7. A salt according to claim 6 wherein the purity of the tertiary amine is 96 to 98%.

8. A salt according to claim 6 wherein the amine feedstock is lauryl dimethylamine.

9. A salt according to claim 1 wherein the water content is reduced to a value of from 3.5 to 9% by weight based on the total weight of said salt.

10. A salt according to claim 8 wherein the water content is reduced to a value of from 3.5 to 9% by weight based on the total weight of said salt.

11. A salt according to claim 2 having an inorganic salt content of less than 12% by weight based on the total weight of said salt.

12. A salt according to claim 2 having an inorganic salt content of less than 9% by weight based on the total weight of said salt.

13. A salt according to claim 2 having an inorganic salt content of less than 0.5% by weight based on the total weight of said salt.

14. A salt according to claim 7 wherein the amine feedstock is lauryl dimethylamine.
